(19) United States
(12) Patent Application Publication
(10) Pub. No.: US 2016/0252789 A1
(43) Pub. Date: Sep. 1, 2016

(54) Liquid Crystal Display Array Substrate and Related Liquid Crystal Display

(71) Applicant: Shenzhen China Star Optoelectronics Technology Co. Ltd., Shenzhen, Guangdong (CN)

(72) Inventor: Hua ZHENG, Shenzhen, Guangdong (CN)

(73) Assignee: Shenzhen China Star Optoelectronics Technology Co. Ltd., Shenzhen, Guangdong (CN)

(21) Appl. No.: 14/346,443

(22) PCT Filed: Jan. 9, 2014
(86) PCT No.: PCT/CN2014/070390

§ 371 Date: Mar. 21, 2014

(30) Foreign Application Priority Data
Dec. 31, 2013 (CN) 201310753035.8

(51) Int. Cl. G02F 1/1362; G02F 1/1343; G02F 1/1368; G02F 1/1335

(52) U.S. Cl. CPC G02F 1/136286; G02F 1/133514; G02F 1/13439; G02F 1/1368; G02F 2001/13606

(57) ABSTRACT

An array substrate used in an LCD is provided. The array substrate includes: a substrate and pixel structures formed on the substrate. Each pixel structure includes: a gate line and a common electrode line formed by the same metal layer on the substrate, two data lines above and crossing the gate line and the common electrode line, a TFT electrically connected to the two data lines and the gate line, a pixel electrode electrically connected to the TFT and deployed between the gate line and the common electrode line. The pixel structures are arranged in a plurality of rows along an extension of the data lines. Two adjacent rows of the pixel structures are arranged in opposite direction in sequence, and at least two adjacent rows of the pixel structures share the common electrode line. The LCD using the array substrate has lower RC delay on data lines, not only improving charging rate of pixel but also reducing cost of additional lines.

### CROSS-REFERENCE TO RELATED APPLICATION

This application claims priority from and the benefit under 35 U.S.C. §119(a) of Chinese Patent Application No. 201310753035.8, filed on Dec. 31, 2013, which is hereby incorporated by reference for all purposes as if fully set forth herein.

### BACKGROUND OF THE INVENTION

1. Field of the Invention

The present invention relates to a thin film transistor liquid crystal display (TFT-LCD) field, more particularly, to a liquid crystal display (LCD) array substrate and a related LCD.

2. Description of the Prior Art

Driving circuits of TFT-LCD usually comprise indispensible components such as gate lines, data lines, thin film transistor (TFT) and common electrode lines (Com). In conventional photo-etching art, gate and common electrode line are usually formed by the same metal layer.

FIG. 1 is a diagram of a pixel structure on a conventional liquid crystal display (LCD) array substrate. The pixel structure is formed on the array substrate by photo-etching with 5 masks. A pixel 1 is formed on the substrate. The size of a pixel structure 16 of the pixel 1 is indicated by a block. The pixel structure 16 comprises:

a gate line 10 and a common electrode line 11 formed by the first metal layer on the substrate;

two data lines 12, crossing above the gate line 10 and the common electrode line 11, formed with the second metal layer;

a TFT 13 electrically connected to the data line 12 and the gate line 11;

a pixel electrode 15 adopting Indium Tin Oxide (ITO) electrodes and electrically connected to the TFT 13 deployed between the gate line 10 and the data line 12.

The TFT 13 comprises an active layer made from amorphous silicon layer, a source and a drain, and links the first and the second metal layer via a through hole 14.

FIG. 2 is a diagram of an array substrate structure on a conventional LCD. In the conventional substrate, a plurality of the pixel structures 16 are arranged as plural rows along extension of the data line 12 and as plural columns in a direction perpendicular to the data line 12. Two adjacent rows of pixel structures are arranged in sequence in the same direction.

As the data line 10 and the common electrode line 11 are formed by the metal layer on the substrate, the data line 10 and the common electrode line 11 are parallel. If the LCD has N rows of pixel (only 4 rows indicated), it must also have N rows of the gate lines 10 and N rows of the common electrode lines 11. Every data line 12 crosses N rows of gate lines 10 and N rows of common electrode lines 11, forming N data/gate line parasitic capacitances (indicated as dotted circles A) and N data/common electrode line parasitic capacitances (indicated as dotted circles B).

The defect of the prior art is that parasitic capacitances cause resistance-capacitance (RC) delay and signal distortion on the data line, resulting in pixel abnormal charging (such as insufficient or erroneous charging).

### SUMMARY OF THE INVENTION

The present invention solves a technical problem by providing a liquid crystal display (LCD) array substrate and a related LCD to reduce RC delay on data lines and improve charging rate of the pixel.

According to the present invention, an array substrate used in a liquid crystal display (LCD) is provided. The array substrate comprises: a substrate and a plurality of pixel structures formed on the substrate. Each pixel structure comprises: a gate line and a common electrode line formed by the same metal layer on the substrate; two data lines above and crossing the gate line and the common electrode line; a thin film transistor (TFT) electrically connected to the two data lines and the gate line; a pixel electrode electrically connected to the TFT and deployed between the gate line and the common electrode line. The pixel structures are arranged in a plurality of rows along the two data lines, two adjacent rows of the pixel structures are arranged in opposite direction in sequence, and at least two adjacent rows of the pixel structures share the common electrode line.

In one aspect of the present invention, the pixel structures are arranged in plural columns vertical to the data lines, and two adjacent columns of the pixel structures are arranged in the same direction in sequence.

In another aspect of the present invention, the gate line and the common electrode line locate at two ends of the pixel structures respectively, and two adjacent rows of the pixel structures with two gate lines remote to each other share the common electrode line.

In still another aspect of the present invention, width of the common electrode line is between 2-20 um.

In yet another aspect of the present invention, the first pixel electrode is a transparent electrode.

According to the present invention, an array substrate used in a liquid crystal display (LCD) is provided. The array substrate comprises: a substrate and a plurality of pixel structures formed on the substrate. Each pixel structure comprises: a gate line and a common electrode line formed by the same metal layer on the substrate; two data lines above and crossing the gate line and the common electrode line; a thin film transistor (TFT) electrically connected to the two data lines and the gate line; a pixel electrode electrically connected to the TFT and deployed between the gate line and the common electrode line. The pixel structures are arranged in a plurality of rows along the two data lines, two adjacent rows of the pixel structures are arranged in opposite direction in sequence, and at least two adjacent rows of the pixel structures share the common electrode line. The gate line and the common electrode line locate at two ends of the pixel structures respectively, and two adjacent rows of the pixel structures with two gate lines remote to each other share the common electrode line.

In one aspect of the present invention, the pixel structures are arranged in plural columns vertical to the data lines, and two adjacent columns of the pixel structures are arranged in the same direction in sequence.

In another aspect of the present invention, width of the common electrode line is between 2-20 um.

In yet another aspect of the present invention, the first pixel electrode is a transparent electrode.

According to the present invention, a liquid crystal display (LCD) comprises: an array substrate; a color filter substrate in opposition to the array substrate; and a liquid crystal layer between the array substrate and the color filter substrate. The array substrate comprises: a substrate and a plurality of pixel structures formed on the substrate. Each pixel structure comprises: a gate line and a common electrode line formed by the same metal layer on the substrate; two data lines above and crossing the gate line and the common electrode line; a thin film transistor (TFT) electrically connected to the two data lines and the gate line; a pixel electrode electrically connected to the TFT and deployed between the gate line and the common electrode line. The pixel structures are arranged in a plurality of rows along the two data lines, two adjacent rows of the pixel structures are arranged in opposite direction in sequence, and at least two adjacent rows of the pixel structures share the common electrode line.

In one aspect of the present invention, the pixel structures are arranged in plural columns vertical to the data lines, and two adjacent columns of the pixel structures are arranged in the same direction in sequence.

In another aspect of the present invention, the gate line and the common electrode line locate at two ends of the pixel structures respectively, and two adjacent rows of the pixel structures with two gate lines remote to each other share the common electrode line.

In still another aspect of the present invention, width of the common electrode line is between 2-20 um.

In yet another aspect of the present invention, the first pixel electrode is a transparent electrode.

Embodiments of the present invention have benefits as below:

In embodiments of the present invention, pixel structures deployed on an array substrate are arranged in plural rows along extension of data lines, and two adjacent rows of pixel structures are arranged in opposition in sequence, therefore two adjacent rows of pixel structures with two gates lines remote to each other share the common electrode line. As a result, chances of data lines and common electrode lines crossing to each other on the array substrate are reduced, therefore number of data lines/common electrode lines parasitic capacitances is reduced; RC delay on data lines decreases, and charging rate of the pixel increases.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of a pixel structure on a conventional liquid crystal display (LCD) array substrate.

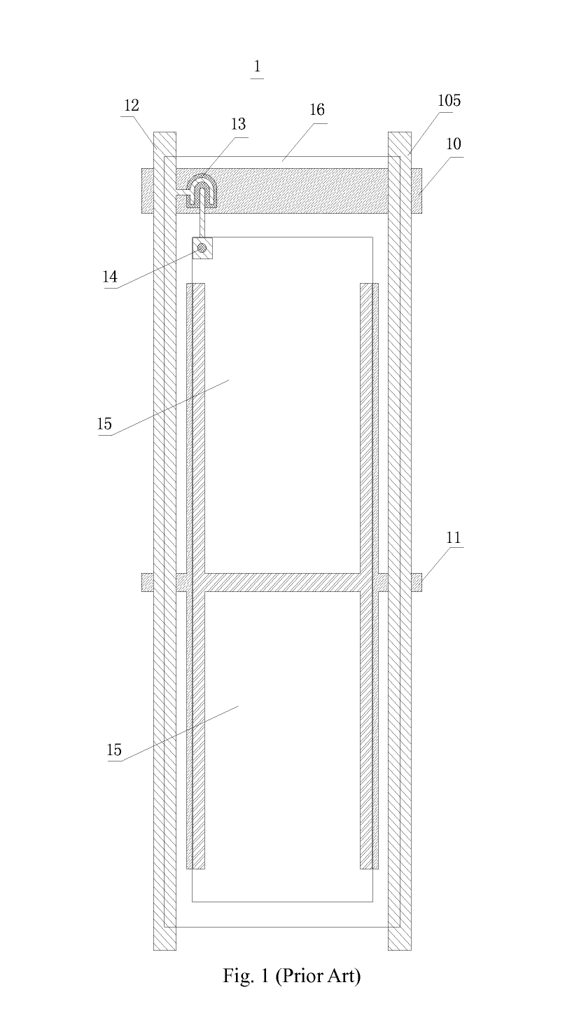

FIG. 2 is a diagram of an array substrate structure on a conventional LCD.

FIG. 3 is a structural diagram of pixel structures on a liquid crystal display array substrate of the present invention.

FIG. 4 is a structural diagram of an embodiment of an LCD array substrate of the present invention.

FIG. 5 illustrates an electric property comparison of prior art and the present invention. Square waveform is theoretically ideal data signal waveform.

### DETAILED DESCRIPTION OF THE PREFERRED EMBODIMENTS

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures.

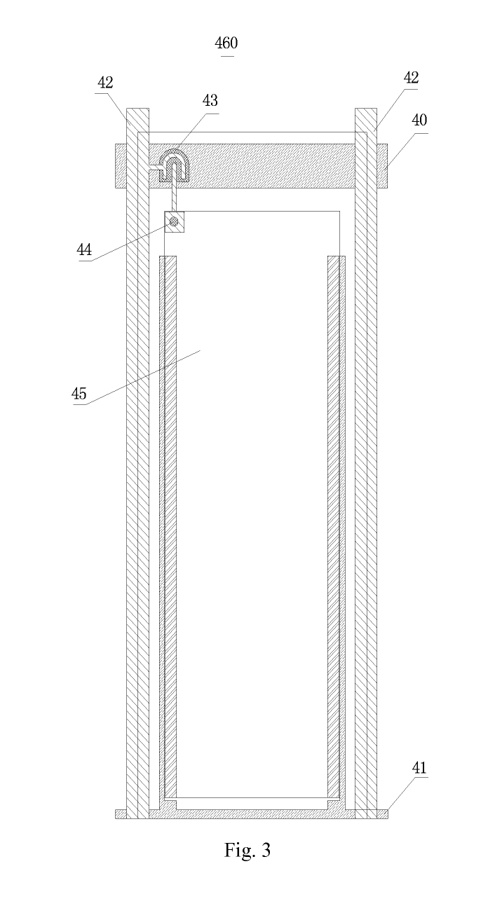

FIG. 3 is a structural diagram of pixel structures on a liquid crystal display (LCD) array substrate of the present invention. A pixel structure 460 is formed on a substrate, whereas the pixel structure 460 is a zone formed by crossing of two adjacent data lines 42, a gate line 40 and a common electrode line 41. The data lines 42 send signals to pixels, the gate line 40 sends scan signals, the common electrode line 41 provides common voltage to the pixels.

In detail, the pixel structure 46 comprises:

the gate line 40 and the common electrode line 41 formed by the same metal layer (the first metal layer) and deployed on the array substrate. The gate line 40 and the common electrode line 41 locate at two ends of the pixel structure 46 respectively;

two data lines 42 formed on the second metal layer deployed above and crossing the gate line 40 and the common electrode line 41;

a thin film transistor (TFT) 43 electrically connected to the data lines 42 and the gate line 41;

a pixel electrode 45 electrically connected to the TFT 43 and deployed between the gate line 40 and the data line 43, which is a transparent electrode and preferably made of Indium Tin Oxide (ITO);

whereas the TFT 43 comprises an active layer made from amorphous silicon layer, a source and a drain formed by the second metal layer, and links the first and the second metal layer via a hole 41.

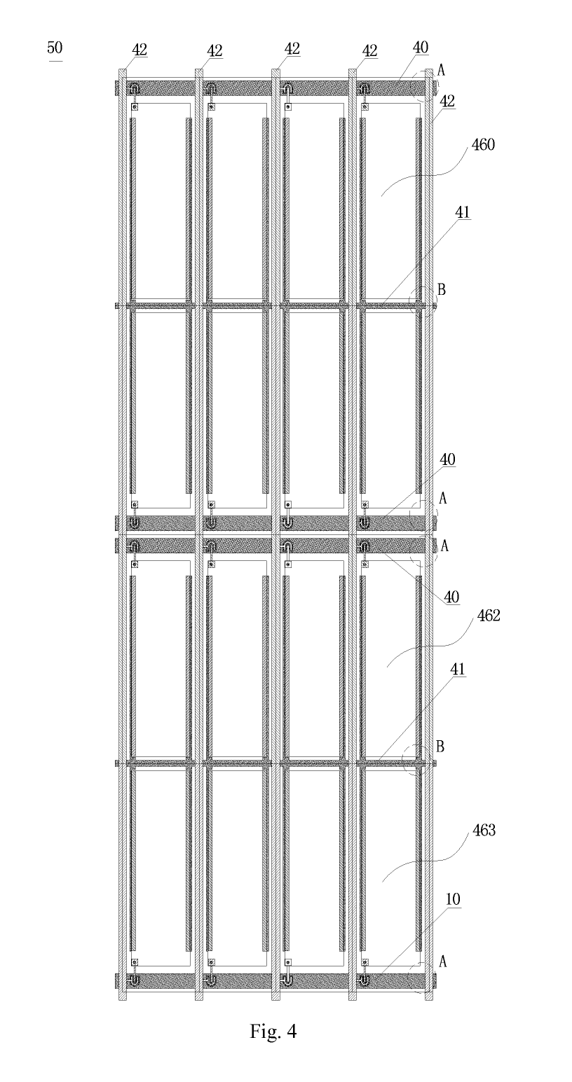

FIG. 4 is a structural diagram of an embodiment of an LCD array substrate of the present invention. In the embodiment, pixel structures deployed on an array substrate 50 are arranged in plural rows along extension of the data line 42, and two adjacent rows of pixel structures are arranged in opposition in sequence. In other words, pixel structures 460, 461, 462 and 463 are arranged in sequence one on the other on the array substrate 500. Arranged in this way, at least part of two adjacent rows of pixel structures share the common electrode line 11. Meanwhile, a plurality of pixel structures are arranged in plural columns in a direction vertical to the data line 42, and two adjacent columns of pixel structures are arranged in the same direction in sequence.

Arrayed in this way, two adjacent rows of pixel structures with two the gate lines 40 remote to each other share the common electrode line 41. Figures indicate that the two adjacent pixel structures 460 and 461 as well as the two adjacent pixel structures 462 and 463 share the common electrode line 11 in pair; meanwhile the common electrode line 11 of the pixel structure 461 and the common electrode line 11 of the pixel structure 462 are remote to each other. Therefore, in the embodiment, the two pixel structures 461 and 462 with the two gate lines 40 remote to each other share the same common electrode line 41, where width of the common electrode line 41 is between 2 um-20 um.

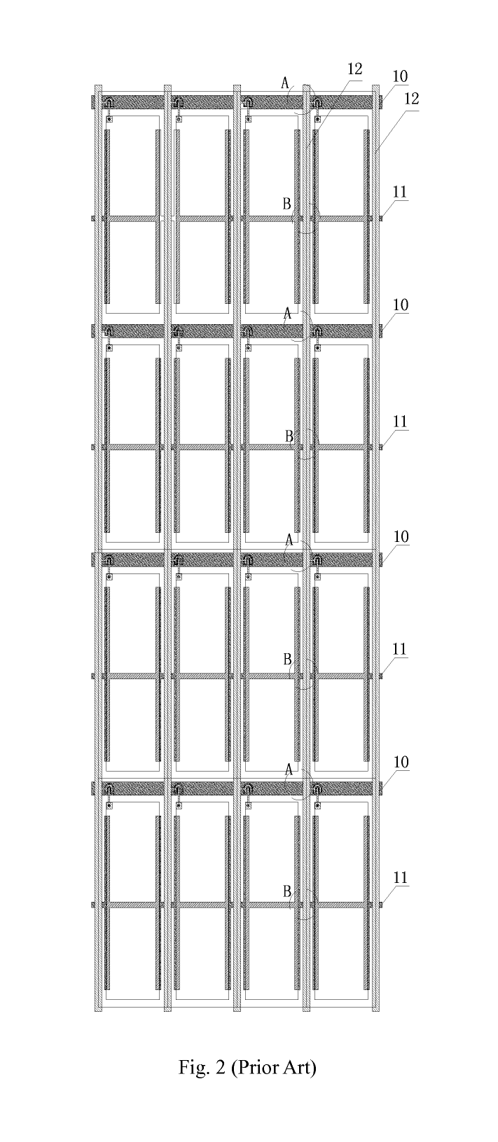

Compared to the conventional array substrate indicated in FIG. 2, the number of data line/gate line parasitic capacitances remains N (indicated as dotted circles A in FIG. 4, which has 4 dotted circles A in every column); however, overlaps of the data line 42 and the common electrode line 41 on the array substrate 50 are halved, i.e. number of data line/common electrode line parasitic capacitances formed by the data line 42 and the common electrode line 41 is halved to N/2 (indicated as dotted circles B in FIG. 4, which has 2 dotted circles B in every column), where N is number of pixel structures. A decrease of data line/common electrode line parasitic capacitances reduces RC delay on data lines, resulting in improvement of pixel charging rate and decrease of erroneous charging.

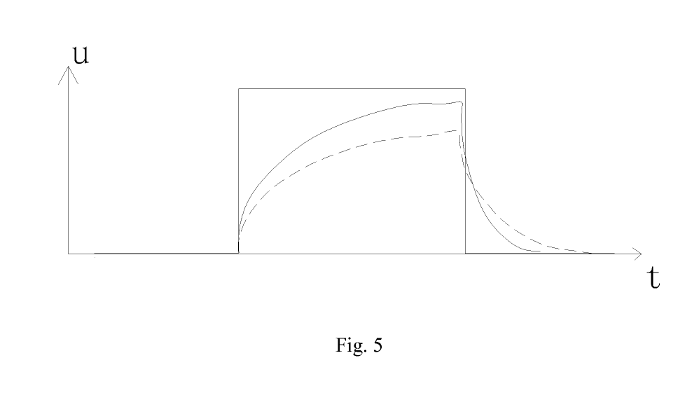

FIG. 5 illustrates an electric property comparison of prior art and the present invention. Square waveform is theoretically ideal data signal waveform. Real line indicates data signal waveform measured in an array substrate of the present invention, and broken line indicated data signal waveform measured in an array substrate of prior art. FIG. 5 shows that signal waveform measured in an array substrate of the present invention is more close to ideal waveform with less RC delay, higher pixel charging rate and lower erroneous charging possibility.

The present invention also relates to an LCD comprising: an array substrate described in FIG. 3 and FIG. 4, a color filter substrate in opposition to the array substrate, and a liquid crystal layer disposed between the array substrate and the color filter substrate.

The embodiment of the present invention has benefits as below:

In embodiments of the present invention, pixel structures deployed on an array substrate are arranged in plural rows along extension of data lines, and two adjacent rows of pixel structures are arranged in opposition in sequence, therefore two adjacent rows of pixel structures with two gate lines remote to each other share a common electrode line. Since a decrease of overlaps of data lines and common electrode line on the array substrate results in a reduction of data lines/common electrode line parasitic capacitances and a decrease of RC delay on data lines, charging rate of pixel increases and possibility of erroneous charging lessens.

Compared to the prior art, the LCD in the present invention has lower RC delay on data lines, not only improving charging rate of pixel but also reducing cost of additional lines.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An array substrate, used in a liquid crystal display (LCD), the array substrate comprising:
a substrate;
a plurality of pixel structures formed on the substrate, wherein every pixel structure comprises:
a gate line and a common electrode line formed by the same metal layer on the substrate;
two data lines above and crossing the gate line and the common electrode line;
a thin film transistor (TFT) electrically connected to the two data lines and the gate line;
a pixel electrode electrically connected to the TFT and deployed between the gate line and the common electrode line;
wherein the pixel structures are arranged in a plurality of rows along the two data lines, two adjacent rows of the pixel structures are arranged in opposite direction in sequence, and at least two adjacent rows of the pixel structures share the common electrode line.

2. The array substrate of claim 1, wherein the pixel structures are arranged in plural columns vertical to the data lines, and two adjacent columns of the pixel structures are arranged in the same direction in sequence.

3. The array substrate of claim 2, wherein the gate line and the common electrode line locate at two ends of the pixel structures respectively, and two adjacent rows of the pixel structures with two gate lines remote to each other share the common electrode line.

4. The array substrate of claim 3, wherein width of the common electrode line is between 2-20 um.

5. The array substrate of claim 4, wherein the first pixel electrode is a transparent electrode.

6. An array substrate, used in a liquid crystal display (LCD), the array substrate comprising:
a substrate;
a plurality of pixel structures formed on the substrate, wherein every pixel structure comprises:
a gate line and a common electrode line formed by the same metal layer on the substrate;
two data lines above and crossing the gate line and the common electrode line;
a thin film transistor (TFT) electrically connected to the two data lines and the gate line;
a pixel electrode electrically connected to the TFT and deployed between the gate line and the common electrode line;
wherein the pixel structures are arranged in a plurality of rows along the two data lines, two adjacent rows of the pixel structures are arranged in opposite direction in sequence, and at least two adjacent rows of the pixel structures share the common electrode line, the gate line and the common electrode line locate at two ends of the pixel structures respectively, and two adjacent rows of the pixel structures with two gate lines remote to each other share the common electrode line.

7. The array substrate of claim 6, wherein the pixel structures are arranged in plural columns vertical to the data lines, and two adjacent columns of the pixel structures are arranged in the same direction in sequence.

8. The array substrate of claim 7, wherein width of the common electrode line is between 2-20 um.

9. The array substrate of claim 8, wherein the first pixel electrode is a transparent electrode.

10. A liquid crystal display (LCD) comprising:
an array substrate;
a color filter substrate in opposition to the array substrate; and
a liquid crystal layer between the array substrate and the color filter substrate;
wherein the array substrate comprises:
a substrate;
a plurality of pixel structures formed on the substrate, wherein every pixel structure comprises:
a gate line and a common electrode line formed by the same metal layer on the substrate;
two data lines above and crossing the gate line and the common electrode line;
a thin film transistor (TFT) electrically connected to the two data lines and the gate line;
a pixel electrode electrically connected to the TFT and deployed between the gate line and the common electrode line;
wherein the pixel structures are arranged in a plurality of rows along the two data lines, two adjacent rows of the pixel structures are arranged in opposite direction in sequence, and at least two adjacent rows of the pixel structures share the common electrode line.

11. The LCD of claim 10, wherein the pixel structures are arranged in plural columns vertical to the data lines, and two adjacent columns of the pixel structures are arranged in the same direction in sequence.

12. The LCD of claim 11, wherein the gate line and the common electrode line locate at two ends of the pixel structures respectively, and two adjacent rows of the pixel structures with two gate lines remote to each other share the common electrode line.

13. The LCD of claim 12, wherein width of the common electrode line is between 2-20 um.

14. The LCD of claim 13, wherein the first pixel electrode is a transparent electrode.
